(19) United States
(12) Patent Application Publication
(10) Pub. No.: US 2026/0186505 A1
(43) Pub. Date: Jul. 2, 2026

(54) ROBOT AND CONTROLLING METHOD THEREOF

(71) Applicant: SAMSUNG ELECTRONICS CO., LTD., Suwon-si (KR)

(72) Inventors: Eunsoll CHANG, Suwon-si (KR); Seungbeom Han, Suwon-si (KR); Chanho Yoon, Suwon-si (KR); Woojeong Kim, Suwon-si (KR)

(73) Assignee: SAMSUNG ELECTRONICS CO., LTD., Suwon-si (KR)

(21) Appl. No.: 19/543,291

(22) Filed: Feb. 18, 2026

Related U.S. Application Data
(63) Continuation of application No. PCT/KR2025/021928, filed on Dec. 16, 2025.

(30) Foreign Application Priority Data
Dec. 23, 2024 (KR) 10-2024-0194426

(51) Int. Cl. G05D 1/686; G05D 105/30; G08B 7/00

(52) U.S. Cl. CPC G05D 1/686; G05D 2105/315; G08B 7/00

(57) ABSTRACT

A robot includes a sensor; a driving assembly configured to move the robot; an input interface; at least one processor; memory storing instructions that, when executed by the at least one processor individually or collectively, cause the robot to: identify a guide mode based on information about a vision state of a user received through the input interface, based on an occurrence of an event related to path guidance being detected through the sensor during moving to a destination while operating in the first mode, provide a visual notification or an audible notification corresponding to the event, and based on the occurrence of the event related to the path guidance being detected by the sensor during moving to the destination while operating in the second mode, provide the audible notification or a tactile notification corresponding to the event.

### CROSS-REFERENCE TO RELATED APPLICATIONS

This application is a continuation of International Application No. PCT/KR2025/021928, filed on Dec. 16, 2025, which is based on and claims priority to Korean Patent Application No. 10-2024-0194426, filed on Dec. 23, 2024, in the Korean Patent Office, the disclosures of which are incorporated by reference herein in their entireties

### BACKGROUND

### 1. Field

The disclosure relates to a robot and a controlling method thereof, and more particularly to a robot for guiding a user with an abnormality in a vision state along a path in a space and a controlling method thereof.

### 2. Description of Related Art

A robot may detect a surrounding environment in real-time based on a sensor, a camera, and the like, and autonomously travel and collect information in addition to performing simple repetitive functions. Such robots may be used to assist people with disabilities. Specifically, a robot may travel in a space (e.g., galleries, libraries, public institutions), and either guide a traveling path to users, or provide various information.

The above description may be provided as related art to aid understanding of the disclosure. No claim or determination is made in any way with respect to whether any of the above description may be applied as prior art associated with the disclosure.

### SUMMARY

According to an aspect of the disclosure, a robot includes: a sensor; a driving assembly configured to move the robot; an input interface; memory storing instructions; and at least one processor including processing circuitry, wherein the instructions, when executed by the at least one processor individually or collectively, cause the robot to: identify a guide mode based on information about a vision state of a user received through the input interface, based on identifying the guide mode being as a first mode, operate in the first mode, and based on an occurrence of an event related to path guidance being detected through the sensor during moving to a destination while operating in the first mode, provide a visual notification or an audible notification corresponding to the event, and based on identifying the guide mode as a second mode, operate in the second mode, and based on the occurrence of the event related to the path guidance being detected by the sensor during moving to the destination while operating in the second mode, provide the audible notification or a tactile notification corresponding to the event.

The robot may further include a projector including a light emitting device, and the instructions, when executed by the at least one processor individually or collectively, may cause the robot to, while operating in the first mode: output light by the projector during moving to the destination, or project visual information for the path guidance on a floor surface of a space by the projector.

The instructions, when executed by the at least one processor individually or collectively, may cause the robot to identify a line-of-sight range of the user through the sensor, and project, by the projector, the visual information on the floor surface in the line-of-sight range of the user.

The instructions, when executed by the at least one processor individually or collectively, may cause the robot to, based on an obstacle being detected through the sensor during moving to the destination while operating in the first mode, project, by the projector, visual information to the obstacle.

The instructions, when executed by the at least one processor individually or collectively, may cause the robot to: identify a moving direction of the user by the sensor, and based on the obstacle being detected in the moving direction, project, by the projector, a light signal to an edge area of the obstacle.

The instructions, when executed by the at least one processor individually or collectively, may cause the robot to: identify a degree of risk of the obstacle based on at least one from among a height of the obstacle, a slope of the obstacle, or a speed of the obstacle, and project the light signal based on a period corresponding to the degree of risk.

The robot may further include a speaker, and the instructions, when executed by the at least one processor individually or collectively, may cause the robot to, based on identifying through the sensor that the user has deviated from a path during moving to the destination, output, by the speaker, the audible notification indicating a state in which the user deviated from a moving path while operating in the first mode or the second mode.

The robot may further include a speaker, and the instructions, when executed by the at least one processor individually or collectively, may cause the robot to output, by the speaker, the audible notification for the path guidance to the destination or output, based on an obstacle being detected by the sensor during the moving to the destination, the audible notification indicating detection of the obstacle by the speaker while operating in the second mode.

The instructions, when executed by the at least one processor individually or collectively, may cause the robot to provide a vibration notification for indicating a change in a moving direction of the robot or detection of an obstacle while operating in the second mode.

The instructions, when executed by the at least one processor individually or collectively, may cause the robot to, based on identifying the guide mode as a third mode, operate in the third mode, and move the robot to the destination to guide the user to the destination.

The instructions, when executed by the at least one processor individually or collectively, may cause the robot to: based on an occurrence of an event related to path guidance to an object present in a space being detected through the sensor during moving to the destination while operating in the first mode, provide the visual notification or the audible notification about the object, based on the occurrence of the event related to the path guidance to the object present in the space being detected through the sensor during moving to the destination while operating in the second mode, provide the audible notification or the tactile notification about the object, and based on the occurrence of the event related to the path guidance to the object present in the space being detected through the sensor during moving to the destination while operating in the third mode, provide the visual notification about the object.

The instructions, when executed by the at least one processor individually or collectively, cause the robot to, while operating in the first mode: project an image corresponding to the object near the object in a size greater than a size of the object by the projector, or output a voice signal describing the object or a voice signal for a text recognized in the object by the speaker.

The robot may further include a speaker, and the instructions, when executed by the at least one processor individually or collectively, may cause the robot to, while operating in the second mode: output a voice signal describing the object or a voice signal for a text recognized in the object by the speaker, or provide a text describing the object or a text recognized in the object by a braille display device.

The robot may further include a projector, and the instructions, when executed by the at least one processor individually or collectively, may cause the robot to project, by the projector, near the object by increasing color contrast of an image corresponding to the object while operating in the third mode.

According to an aspect of the disclosure, a method of controlling a robot, includes: identifying a guide mode based on information about a vision state of a user; based on identifying the guide mode as a first mode, operating in the first mode, based on an occurrence of an event related to path guidance being detected during moving to a destination while operating in the first mode, providing a visual notification or an audible notification corresponding to the event; and based on identifying the guide mode as a second mode, operating in the second mode, and based on the occurrence of the event related to the path guidance being detected during moving to the destination while operating in the second mode, the audible notification or a tactile notification corresponding to the event.

The method may further include, while operating in the first mode: outputting, by a projector of the robot, light during moving to the destination; or projecting, by the projector, visual information for the path guidance on a floor surface of a space.

The method may further include: identifying a line-of-sight range of the user through a sensor of the robot, and projecting, by the projector, the visual information on the floor surface in the line-of-sight range of the user.

The method may further include, based on an obstacle being detected through a sensor of the robot during moving to the destination while operating in the first mode, projecting, by the projector, visual information to the obstacle.

The method may further include: identify a moving direction of the user by the sensor, and based on the obstacle being detected in the moving direction, projecting, by the projector, a light signal to an edge area of the obstacle.

The method may further include: identifying a degree of risk of the obstacle based on at least one from among a height of the obstacle, a slope of the obstacle, or a speed of the obstacle, and based on the obstacle being detected in the moving direction, projecting, by the projector, the light signal to an edge area of the obstacle.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram schematically illustrating a robot according to an embodiment;

FIG. 2 is a diagram illustrating an exterior of a robot according to an embodiment;

FIG. 3 is a block diagram illustrating a configuration of a robot according to an embodiment;

FIG. 4 is a block diagram illustrating a detailed configuration of a robot according to an embodiment;

FIG. 5 is a flowchart illustrating an example of an operation of a robot providing notification to a user according to an embodiment;

FIG. 6 is a diagram illustrating an example of an operation of a robot providing a visual notification or an audible notification to guide a path to a user in a first mode according to an embodiment;

FIG. 7A and FIG. 7B are diagrams illustrating an example of an area at which a robot projects visual information to guide a path to a user in a first mode according to an embodiment;

FIG. 8 is a diagram illustrating an example of an operation of a robot providing notification to a user when the user deviates from a path in a first mode according to an embodiment;

FIG. 9 is a diagram illustrating an example of an operation of a robot providing notification to a user when an obstacle is detected in a first mode according to an embodiment;

FIG. 10 is a diagram illustrating an example of an operation of a robot providing a notification to a user when an obstacle is detected in a first mode according to an embodiment;

FIG. 11 is a diagram illustrating an example of an operation of a robot providing an audible notification or a tactile notification to guide a path to a user in a second mode according to an embodiment;

FIG. 12 is a diagram illustrating an example of an operation of a robot providing a notification to a user when an obstacle is detected in a second mode according to an embodiment;

FIG. 13 is a diagram illustrating an example of an operation of a robot providing a notification to a user when an obstacle is detected in a second mode according to an embodiment;

FIG. 14 is a flowchart illustrating an example of an operation of a robot providing a notification to a user according to an embodiment;

FIG. 15 is a diagram illustrating an example of an operation of a robot providing a notification to a user when an event related to path guidance to an object in a space is occurred in a first mode according to an embodiment;

FIG. 16 is a diagram illustrating an example of an operation of a robot providing a notification to a user when an event related to path guidance to an object in a space is occurred in a first mode according to an embodiment;

FIG. 17 is a diagram illustrating an example of an operation of a robot providing a notification to a user when an event related to path guidance to an object in a space is occurred in a second mode according to an embodiment; and

FIG. 18 is a diagram illustrating an example of an operation of a robot providing a notification to a user when an event related to path guidance to an object in a space is occurred in a third mode according to an embodiment.

### DETAILED DESCRIPTION

Terms used in the disclosure will be briefly described, and the disclosure will be described in detail. In the disclosure, an expression “at least one from among a, b, or c” may refer to “a”, “b”, “c”, “a and b”, “a and c”, “b and c”, or “all of a, b, and c”.

The terms used in the disclosure are general terms selected that are currently widely used considering their function herein. However, the terms may change depending on intention, legal or technical interpretation, emergence of new technologies, and the like, as understood by those skilled in the related art. Further, in certain cases, there may be terms arbitrarily selected, and the meaning of the term will be disclosed in greater detail in the corresponding description. Accordingly, the terms used herein are not to be understood simply as their designation, but based on the meaning of the term and the overall context of the disclosure.

A singular expression includes a plural expression, unless otherwise specified. The terms used in the disclosure, including technical or scientific terms, may have the same meaning as the terms generally understood by those of ordinary skill in the related field of art. Terms including ordinal numbers such as “first” or “second” used in the disclosure may be used in describing various elements, but the elements are not limited by the above-described terms. The above-described terms may be used only for the purpose of distinguishing one element from another element.

Throughout the disclosure, when a certain portion is described as “including” a certain element, this may mean that another element may be further included rather than excluding the another element, unless otherwise specified. Terms such as “part” or “module” described in the disclosure may mean a unit that processes at least one function or operation, and the above may be implemented with hardware, software, or implemented with a combination of hardware and software.

The term “and/or” may include a combination of a plurality of related elements described or any element from among the plurality of related elements described.

The various elements and areas of the drawings are schematically illustrated. Accordingly, the technical spirit of the disclosure is not limited by relative sizes and distances illustrated in the accompanying drawings.

The disclosure will be described below with reference to the accompanying drawings.

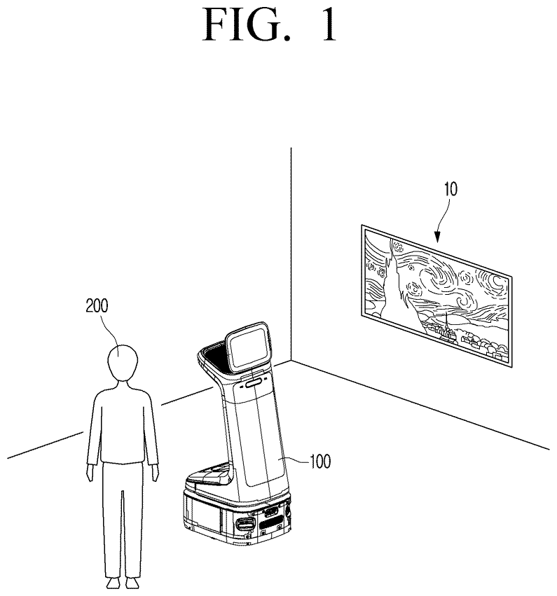

FIG. 1 is a diagram schematically illustrating a robot according to an embodiment.

Referring to FIG. 1, a robot 100 may move in a space 10, and perform various operations such as path guidance for a user 200.

According to an embodiment, the robot 100 may identify a surrounding space 10 and move autonomously. For example, the robot 100 may detect or sense positions and surrounding objects by searching the surroundings, and avoiding the surrounding objects using the detected information or moving on its own to an optimal moving path. The term “moving” may be substituted with expressions such as “travel” and the like. The objects may include obstacles of various types present in the space 10 at which the robot 100 is positioned. For example, the objects may include doors, walls, furniture, home appliances, and the like. However, embodiments are not limited thereto.

The space 10 may mean an area that the robot 100 travels. The space 10 may include various places such as a gallery, a library, a public institution, a hotel, a store, a supermarket, a restaurant, and the like. However, embodiments are not limited thereto. The robot 100 may provide information to a user 200 while traveling in the space 10. The information may include information about a traveling path or information about an object positioned in the space 10.

The information about a traveling path may include information for guiding a moving direction of a user, information about an obstacle, and information about a moving state (e.g., whether there is deviation from the path) of a user. The information about an object positioned in the space 10 may include information about a drawing, a text, an object, or the like positioned in the space 10.

According to an embodiment, the robot 100 may provide the user 200 with information based on at least one from among a visual notification, an audible notification, or a tactile notification. The visual notification may include providing information to the user 200 through a visual element. The audible notification may include providing information to the user 200 through sound. The tactile notification may include a notification providing information to the user 200 through tactile elements such as vibration or a braille device.

The user 200 may include persons with visual impairment. The persons with visual impairment may include persons with color vision deficiency, persons with low vision or visual impairment, and persons with total blindness. However, embodiments are not limited thereto, and the user 200 may include persons requiring travel guidance such as children, seniors, and persons with various disabilities.

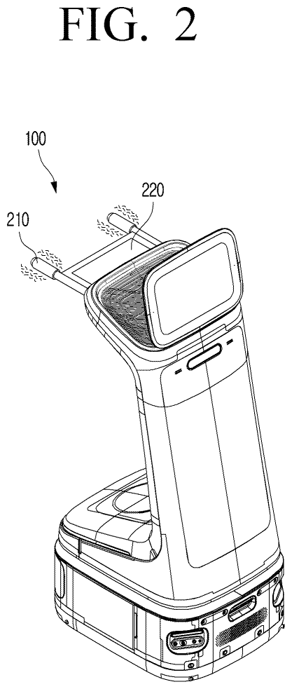

FIG. 2 is a diagram illustrating an exterior of a robot according to an embodiment.

Referring to FIG. 2, the robot 100 may be an autonomous mobile robot (AMR). The robot 100 may autonomously travel along a moving path based on the moving path determined by a user input. The robot 100 may include a handle 210 or a braille display device 220.

The user 200 may move in the space while holding the handle 210. According to an embodiment, the handle 210 may be configured to provide a tactile notification to the user 200. For example, the handle 210 may include a vibration motor inside thereof. The vibration motor may provide a vibration notification to the user 200 based on control by the processor.

The braille display device 220 may include a device that converts text to braille in real-time. For example, the braille display device 220 may be configured in a form in which braille cells which are formed with a plurality of pins are arranged in one row. The robot 100 may convert information to braille through the braille display device 220 and provide to the user 200.

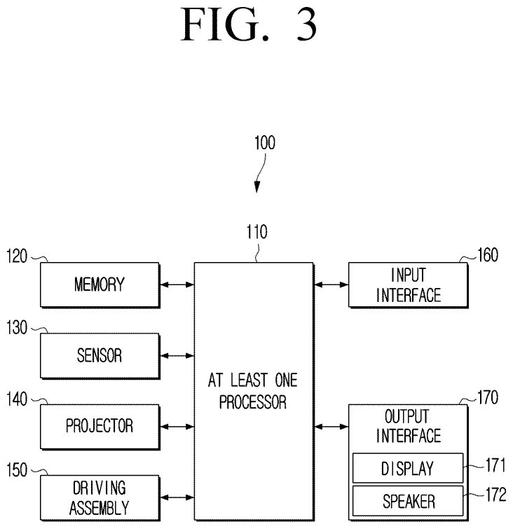

FIG. 3 is a block diagram illustrating a configuration of a robot according to an embodiment.

Referring to FIG. 3, the robot 100 may include a processor 110, a memory 120, a sensor 130, a projection part (or projector) 140, a driving part (or driving assembly) 150, an input interface 160, and an output interface 170. The processor 110 may represent a single processor or multiple processors. However, the configuration described above is merely an example, and in realizing the disclosure, a new configuration may be added or a portion of the configurations may be omitted in addition to the configurations described above.

The processor 110 may control overall operations of the robot 100. For example, the processor 110 may control, by executing one or more instructions stored in the memory 120 of the robot 100, the overall operations of the robot 100 to provide notifications to the user 200.

The processor 110 may include one or more from among a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The processor 110 may control one or a random combination from among other elements of the robot 100, and perform an operation associated with communication or data processing. The processor 110 may execute one or more programs or instructions stored in the memory 120 of the robot 100. For example, the processor 110 may perform, by executing the one or more instructions stored in the memory 120 of the robot 100, a method according to an embodiment of the disclosure.

When a method according to an embodiment of the disclosure includes a plurality of operations, the plurality of operations may be performed by one processor, or performed by a plurality of processors. For example, when a first operation, a second operation, and a third operation are performed by a method according to an embodiment, the first operation, the second operation, and the third operation may all be performed by a first processor, or the first operation and the second operation may be performed by a first processor (e.g., a general-purpose processor) and the third operation may be performed by a second processor (e.g., an artificial intelligence dedicated processor).

The processor 110 may be implemented as a single core processor that includes one core, or implemented as one or more multicore processors that include a plurality of cores (e.g., a homogeneous multicore or a heterogeneous multicore). When the processor 110 is implemented as multicore processors, each of the plurality of cores included in the multicore processors may include a memory inside the processor such as a cache memory and an on-chip memory, and a common cache shared by the plurality of cores may be included in the multicore processors. For example, each of the plurality of cores (or a portion from among the plurality of cores) included in the multicore processors may independently read and perform a program command for implementing a method according to an embodiment of the disclosure, or read and perform a program command for implementing a method according to an embodiment of the disclosure due to a whole (or a portion) of the plurality of cores being interconnected.

When a method according to an embodiment of the disclosure includes a plurality of operations, the plurality of operations may be performed by one core from among the plurality of cores or performed by the plurality of cores included in the multicore processors. For example, when a first operation, a second operation, and a third operation are performed by a method according to an embodiment, the first operation, the second operation, and the third operation may all be performed by a first core included in the multicore processors, or the first operation and the second operation may be performed by the first core included in the multicore processors and the third operation may be performed by a second core included in the multicore processors.

In the embodiments of the disclosure, the processor 110 may refer to a system on chip (SoC), the single core processor, or the multicore processors in which one or more processors and other electronic components are integrated or a core included in the single core processor or the multicore processors. The core herein may be implemented as the CPU, the GPU, the APU, the MIC, the DSP, the NPU, the hardware accelerator, the machine learning accelerator, or the like, but the embodiments of the disclosure are not limited thereto.

The memory 120 may store instructions, data structures, and program codes. Operations performed by the processor 110 may be implemented by executing the instructions or codes of the programs stored in the memory 120.

The memory 120 may include a flash memory, a hard disk, a multimedia card (e.g., microSD), a card-type memory (e.g., SD or XD memory, etc.), and include a non-volatile memory including at least one from among a read-only memory (ROM), an electrically erasable programmable read-only memory (EEPROM), a programmable read-only memory (PROM), a magnetic memory, a magnetic disk, an optical disc and a volatile memory such as a random access memory (RAM) or a static random access memory (SRAM).

The memory 120 may store one or more instructions and/or programs for the robot 100 to perform an operation for providing notifications to users.

The sensor 130 may be configured to sense information related to the surrounding environment of the robot 100. The processor 110 may obtain information about the surrounding environment of the robot 100 based on sensing values obtained by the sensor 130.

According to an embodiment, the sensor 130 may include one or more cameras. The processor 110 may obtain images by capturing the surroundings of the robot 100 (e.g., a front direction of the robot 100) using a camera. For example, the camera may include an RGB camera, a depth camera, and the like. The depth camera may be implemented using a stereo method, a Time of Flight (ToF) method, or the like.

According to an another example, the sensor 130 may include a light detection and ranging sensor (LiDAR) sensor. The LiDAR sensor may output a laser in a 360 degree direction, and when a laser reflected from an object is received, the LiDAR sensor may obtain geographical information about a space by analyzing a difference in time taken until the laser is reflected from the object and returned and an intensity of a signal corresponding to the received laser. The geometry information may include positions, distances, directions, and the like of objects present in the surrounding of the robot 100. The LiDAR sensor may provide the obtained information to the processor 110.

The processor 110 may obtain position information about objects surrounding, near, or adjacent to the robot 100 using the sensor 130. The position information about objects may include distances between objects, directions of objects, and the like with respect to the robot 100.

The processor 110 may perform simultaneous localization and mapping (SLAM).

According to an embodiment, the one or more processors 110 may generate a map of a space using information obtained through the LiDAR sensor. For example, the processor 110 may obtain geometry information about a space using the LiDAR sensor, and compare the obtained geometry information with pre-stored geometry information, or identify a position (e.g., coordinate values) of the robot 100 in a map by comparing the obtained geometry information.

The projection part 140 may be configured to project a light signal or an image to the outside. According to various embodiments of the disclosure, the projection part 140 may be implemented with various projection methods, such as a cathode-ray tube (CRT) method, a liquid crystal display (LCD) method, a digital light processing (DLP) method, or a laser method.

The projection part 140 may include light sources of various types. For example, the projection part 140 may include at least one light source from among a lamp, a light emitting diode (LED), or a laser.

The projection part 140 may perform various functions for adjusting an output image under control of the processor 110. For example, the projection part 140 may perform functions such as zoom, keystone, quick corner keystone (e.g., four-corner keystone), lens shift, and the like.

For example, the projection part 140 may enlarge or reduce an image according to a distance from a screen (e.g., projection distance). For example, a zoom function may be performed according to the distance from the screen. For example, the zoom function may include a hardware method of adjusting a size of a picture by moving the lens and a software method of adjusting the size of the picture by cropping the image, and the like. When the zoom function is performed, an adjustment of a focal point of the image may be necessary. For example, a method of adjusting the focal point may include a manual focusing method, an electrically-driven method, and the like. The manual focusing method may mean a method of manually adjusting the focal point, and the electrically-driven method may mean a method of automatically adjusting the focal point by a monitor embedded with a projector when the zoom function is performed. When the zoom function is performed, the projection part 140 may provide a digital zoom function through software.

The projection part 140 may perform a keystone correction function. When a height of a front projection does not match, the picture may be distorted toward the top or bottom thereof. The keystone correction function may mean a function for correcting a distorted picture. For example, correction may be performed using a horizontal keystone when distortion occurs toward the left and right directions of the picture, and correction may be performed using a vertical keystone when distortion occurs toward the top and bottom directions thereof. A quick corner (4-corner) keystone correction function may be a function for correcting the picture when a center area of the picture is normal but balance of the edge area is not a match. The lens shift function may be a function that transfers the picture as is in case that the picture is off screen.

The projection part 140 may provide the zoom/keystone/focus function by automatically analyzing the surrounding environment and projection environment without a user input. For example, the projection part 140 may automatically provide the zoom/keystone/focus function based on the distance between the robot 100 detected through the sensor, which includes a depth camera, a distance sensor, an infrared sensor, and an illuminance sensor, etc., and the screen, information about the space in which the robot 100 is currently positioned, information about an amount of ambient light, and the like.

The projection part 140 may provide a lighting function using a light source. For example, the projection part 140 may provide the lighting function by outputting the light source using a light emitting diode (LED). The projection part 140 according to various embodiments may include one LED, and the robot 100 according to another embodiment may include a plurality of LEDs. The projection part 140 may output a light source using a surface-emitting LED according to an implementation. The surface-emitting LED may mean an LED having a structure in which an optical sheet is disposed at an upper side of the LED for the light source to be uniformly distributed and output. For example, when a light source is output through the LED, the light source may be uniformly distributed through the optical sheet, and the light source distributed through the optical sheet may be incident on a display panel.

The projection part 140 may provide the user with a dimming function for adjusting the intensity of the light source. The projection part 140 may provide the dimming function under control of the processor 110. For example, the projection part 140 may control the LED to output the intensity of the light source.

The driving part 150 may control movement of the robot 100 under control of the processor 110.

According to an embodiment, the driving part 150 may move the robot 100, or stop the robot 100 that is in movement, and control a moving direction, a moving speed, and the like of the robot 100.

For example, the driving part 150 may include a plurality of wheels and at least one motor to drive the wheels. The wheel motor may control the moving direction, the moving speed, and the like of the robot 100 under controlling a rotation direction and a rotation speed of the wheels. For example, when the robot 100 includes two wheels (e.g., a left wheel and a right wheel), the wheel motor may include a left wheel motor for controlling a rotation direction and a moving speed of a left wheel and a right wheel motor for controlling a rotation direction and a moving speed of the right wheel.

The input interface 160 may include circuitry. The input interface 160 may receive a user input, and transfer the user input to the processor 110. For example, the input interface 160 may receive various user inputs for setting or selecting various functions supported in the robot 100.

The input interface 160 may include input devices of various types.

According to an embodiment, the input interface 160 may include a physical button. The physical button may include a function key or a dial button. The physical button may be implemented as one or more keys.

According to an embodiment, the input interface 160 may receive a user input using a touch method. For example, the input interface 160 may be implemented as a touch screen that also performs a function of a display 171.

According to an embodiment, the input interface 160 may receive a user voice through a microphone. The processor 110 may perform a function corresponding to the user voice using voice recognition. For example, the processor 110 may convert the user voice to text data using a Speech to Text (STT) function, obtain control command data based on the text data, and perform a function corresponding to the user voice based on the control command data. According to an embodiment, the STT function may be performed in an external server.

The output interface 170 may include the display 171 and a speaker 172.

The display 171 may display various screens. The display 171 may be implemented as a display that includes self-emissive devices or, as a display that includes non-emissive devices and a backlight. For example, the display 171 may be implemented as displays of various forms, such as a Liquid Crystal Display (LCD), an Organic Light Emitting Diode (OLED) display, a Light Emitting Diode (LED) display, a micro LED display, a Mini LED display, a Quantum dot light-emitting diode (QLED) display, and the like. However, embodiments are not limited thereto.

The speaker 172 may output audio signals. The processor 110 may output a response message, and the like corresponding to an audible notification and a user input through the speaker 172.

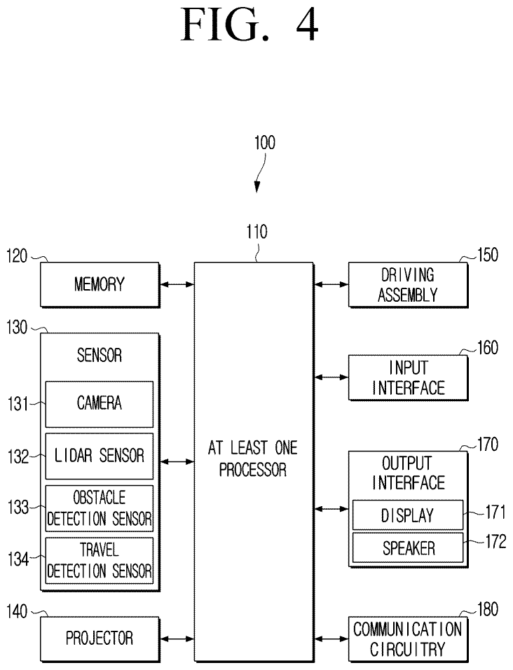

FIG. 4 is a block diagram illustrating a detailed configuration of a robot according to an embodiment.

Referring to FIG. 4, the robot 100 may include the processor 110, the memory 120, the sensor 130, the projection part 140, the driving part 150, the input interface 160, the output interface 170, and a communication circuitry 180. Detailed descriptions on configurations overlapping with the configurations shown in FIG. 3 from among the configurations shown in FIG. 4 will be omitted.

The sensor 130 may detect a structure and object obstacles in a space. The sensor 130 may include a camera 131 and a LiDAR sensor 132. For example, the sensor 130 may include at least one from among an obstacle detection sensor 133 and a travel detection sensor 134.

The obstacle detection sensor 133 may detect objects in the surrounding of the robot 100. For example, the obstacle detection sensor 133 may include at least one from among an ultrasonic sensor, an infrared sensor, a radio frequency (RF) sensor, a geomagnetic sensor, and a position-sensitive device (PSD) sensor. The obstacle detection sensor 133 may detects objects that are present in a front direction, rear direction, a side surface or on a moving path of the robot 100. The obstacle detection sensor 133 may provide information about the detected objects to the processor 110.

The travel detection sensor 134 may detect a travel of the robot 100. For example, the travel detection sensor 134 may include at least one from among a gyro sensor, a wheel encoder, and an acceleration sensor. The gyro sensor may detect the rotation direction and a rotation angle of the robot 100. The wheel encoder may detect a number of rotations of the wheel of the robot 100. The acceleration sensor may detect changes in the speed of the robot 100. The travel detection sensor 134 may provide the detected travel information to the processor 110.

The communication circuitry 180 may perform data communication with an electronic apparatus under control of the processor 110. The electronic apparatus may include a server, a home appliance, a mobile device (e.g., smartphone, tablet personal computer (PC), wearable device, etc.), and the like.

For example, the communication circuitry 180 may include communication circuitry capable of performing data communication between the robot 100 and the electronic apparatus using at least one from among data communication methods that include a wired local area network (LAN), a wireless LAN, Wi-Fi, Wi-Fi Direct, Bluetooth, ZigBee, infrared communication (e.g., infrared Data Association (IrDA)), Bluetooth Low Energy (BLE), Near Field Communication (NFC), Wireless Broadband Internet (WiBro), World Interoperability for Microwave Access (WiMAX), Shared Wireless Access Protocol (SWAP), Wireless Gigabit (WiGig), and RF communication.

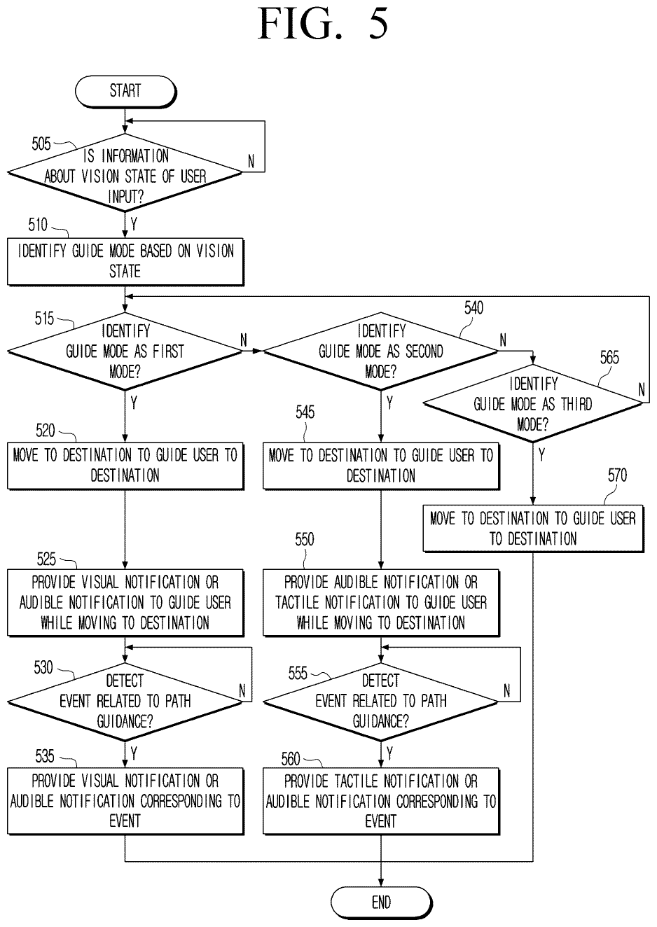

FIG. 5 is a flowchart illustrating an example of an operation of a robot providing a notification to a user according to an embodiment.

The processor 110 of the robot 100 may perform at least one operation from among the operations in FIG. 5. Instructions, which are stored in the memory 120 of the robot 100, may cause the robot 100 to perform the operations in FIG. 5, when the instructions are executed by the processor 110 of the robot 100.

In operation 505 of FIG. 5, according to an embodiment, the robot 100 may identify whether information about a vision state of the user is input.

The information about a vision state may include information for identifying a guide mode. For example, the information about a vision state may include information about whether the user is a person with visual impairment, whether the user is a person with color vision deficiency, and an eyesight and a field of view of the user.

According to an embodiment, the robot 100 may receive the information about a vision state from the user through the input interface 160. For example, the robot 100 may receive a touch input from the user. For example, the robot 100 may display a user interface (UI) including a plurality of options (e.g., a person with low vision or visual impairment, a person with total blindness, and a person with color vision deficiency) for selecting the vision state on the display 171. The robot 100 may receive a touch input on the UI from the user 200. However, the embodiment is not limited thereto, and the robot 100 may receive voice information (e.g., “person with low vision or visual impairment”, “person with total blindness”, or “person with color vision deficiency”) from the user through the microphone.

However, the embodiment is not limited thereto, and the robot 100 may receive eyesight and field of view from the input of the user 200. For example, the robot 100 may identify the user 200 as a person with total blindness when the eyesight and/or viewing angle of the user 200 corresponds to that of a person with low vision or visual impairment (e.g., eyesight of 0 or viewing angle of 0 degrees). For example, the robot 100 may identify the user as a person with low vision or visual impairment when the eyesight and/or viewing angle of the user 200 corresponds to that of a person with low vision or visual impairment (e.g., less than or equal to eyesight of 0.3 or less than or equal to viewing angle of 20 degrees). A standard for the robot 100 to identify persons with total blindness and persons with low vision or visual impairment may be different according to countries or their legislations.

In operation 505-Y and operation 510 in FIG. 5, according to an embodiment, the robot 100 may identify a guide mode based on the vision state of the user. For example, the guide mode of the robot 100 may be identified as a first mode when the vision state of the user is identified as a person with low vision or visual impairment, the guide mode of the robot 100 may be identified as a second mode when the vision state of the user is identified as a person with total blindness, and the guide mode of the robot 100 may be identified as a third mode when the vision state of the user is identified as a person with color vision deficiency.

According to an embodiment, the robot 100 may identify the vision state of the user 200 (e.g., a person with low vision or visual impairment, a person with total blindness, and a person with color vision deficiency) based on the information about a vision state received from the user 200. For example, the robot 100 may identify the vision state of the user 200 as a person with low vision or visual impairment when receiving a touch input on the UI corresponding to persons with low vision or visual impairment from among the plurality of options from the user 200, identify the vision state of the user 200 as a person with total blindness when receiving a touch input on the UI corresponding to persons with total blindness from among the plurality of options, and identify the vision state of the user 200 as a person with color vision deficiency when receiving a touch input on the UI corresponding to persons with color vision deficiency from among the plurality of options from the user 200. However, the embodiment is not limited thereto, and when voice information is received from the user 200, the vision state corresponding to the voice information may be identified.

In operation 515 of FIG. 5, according to an embodiment, the robot 100 may identify whether the guide mode is the first mode. In operation 515-Y and operation 520, according to an embodiment, the robot 100 may move to a destination to guide the user 200 to the destination when the guide mode is identified as the first mode.

According to an embodiment, the robot 100 may obtain the destination based on the user input. For example, the robot 100 may determine the destination based on the user input on the touch screen. For example, the robot 100 may receive a touch input for a point corresponding to a destination on a map that corresponds to a space through the touch screen. For example, the robot 100 may receive input of information about a destination as text through the touch screen. In an example, the user 200 may input “bathroom” through a keyboard application displayed on the display 171. According to an embodiment, the robot 100 may determine the destination based on the voice information received through the microphone. For example, the robot 100 may determine the destination as the bathroom based on receiving the voice information (e.g., “bathroom”) through the microphone.

According to an embodiment, the robot 100 may obtain a moving path directed toward the destination. For example, the robot 100 may obtain the moving path based on the position of the robot 100 and the position of the destination on the map that corresponds to the space. Information about the map may be stored in the memory 120. For example, the robot 100 may generate a map of a space while traveling in the space and store in the memory 120. The robot 100 may identify a travelable area on the map and obtain the moving path directed toward the destination from the position of the robot 100 in the travelable area. The robot 100 may obtain a plurality of points (e.g., waypoints) positioned on the moving path. The robot 100 may control the driving part 150 to travel to a first point among a plurality of points, to travel to a second point when identified as being located at the first point, and finally to travel to a destination.

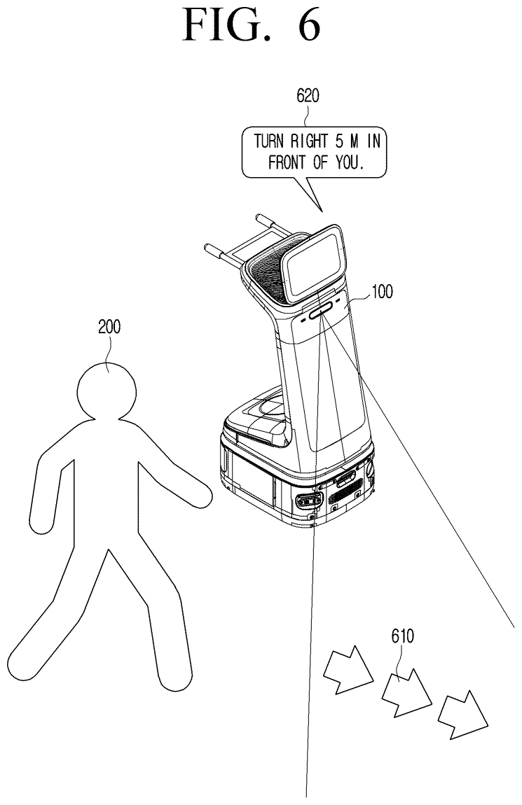

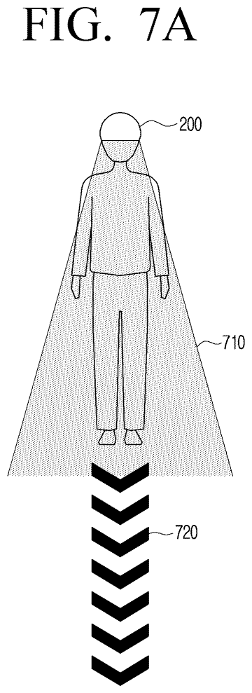

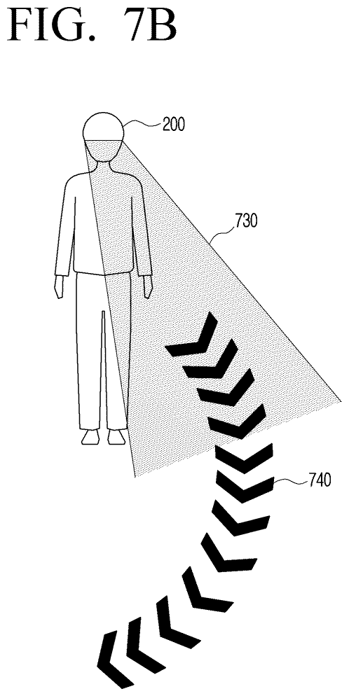

In operation 525 of FIG. 5, according to an embodiment, the robot 100 may provide a visual notification or an audible notification to the user 200 to guide along a path while moving to the destination. Descriptions on an operation of the robot 100 providing the user with a visual notification or an audible notification to guide along a path in the first mode will be described in detail with reference to FIG. 6 to FIG. 7B below.

FIG. 6 is a diagram illustrating an example of an operation of a robot providing a visual notification or an audible notification to guide a path to a user in a first mode according to an embodiment.

Notifications for guiding the user 200 along a path may include the moving direction of the user, and information necessary in case that the user 200 moves to the destination such as a moving distance. The robot 100 may obtain the moving direction and the moving distance based on the moving path.

In an example, the robot 100 may identify a direction parallel with the moving path as the moving direction. In an example, the robot 100 may identify a direction from a position of the user 200 toward the robot 100 as the moving direction. For example, the robot 100 may identify a distance remaining until the destination or a distance from a current position to a next point from among the plurality of points on the moving path as the moving distance.

Referring to FIG. 6, according to an embodiment, the robot 100 may project visual information 610 to guide a path to a destination through the projection part 140. The visual information 610 to guide a path to a destination may include the moving direction. The robot 100 may project the moving direction in the form of an arrow on a floor area.

However, the embodiment is not limited thereto, and the visual information 610 to guide a path to a destination may include the moving distance. For example, the robot 100 may provide the user 200 with the moving distance (e.g., 5 m) as a number.

According to an embodiment, the robot 100 may project the visual information 610 on the floor area. The floor area may include an area corresponding to the floor surface in a front direction of the user 200 or an area corresponding to the floor surface between the robot 100 and the user 200.

According to an embodiment, the robot 100 may output light through a light emitting device of the robot 100 while moving to the destination. The light emitting device may be positioned at a rear surface of the robot 100. The user 200 may detect the position of the robot 100 through a light signal output from the light emitting device. The robot 100 may include a light emitting device (LED). The robot 100 may output a light signal (e.g., a yellow light signal) through the light emitting device based on a certain period (e.g., 0.1 seconds).

According to an embodiment, the robot 100 may provide the user 200 with audible information 620 to guide a path to a destination through the speaker 172. For example, the robot 100 may provide information about a moving direction (e.g., right turn, left turn, straight ahead) or a moving distance (e.g., 1 m) to the user 200 through the speaker 172. In an example, the robot 100 may provide the user 200 with a voice that includes audible information 620 (e.g., “turn right 5 m in front of you”) based on the moving path.

FIG. 7A and FIG. 7B are diagrams illustrating an example of an area at which a robot projects visual information to guide a path to a user in a first mode according to an embodiment.

FIG. 7A is a diagram illustrating an example of an operation of the robot projecting visual information based on a line-of-sight range of the user according to an embodiment.

Referring to FIG. 7A, according to an embodiment, the robot 100 may obtain an area for projecting visual information 720 based on a line-of-sight range 710 of the user 200. For example, the robot 100 may project the visual information 720 to an area (hereinafter, referred to as a “first area”) corresponding to the floor surface in the line-of-sight range 710 of the user 200.

According to an embodiment, the robot 100 may obtain the line-of-sight range 710 of the user 200 based on an image obtained through the camera 131 using an artificial intelligence model. The robot 100 may extract an area corresponding to the face and eyes of the user 200 from the image. The robot 100 may identify the head direction of the user 200 by analyzing the facial area. The robot 100 may obtain the pupil direction by analyzing an area corresponding to the eyes. The robot 100 may obtain the line-of-sight direction of the user 200 based on the head direction and the pupil direction of the user 200.

According to an embodiment, the robot 100 may obtain the line-of-sight range of the user 200 based on the line-of-sight direction of the user 200 and the vision state of the user 200. The vision state of the user 200 may include information about the viewing angle of the user 200. For example, when the viewing angle of the user 200 is 20 degrees, the robot 100 may identify the line-of-sight range of the user 200 as a range corresponding to 10 degrees to the left and right of a viewing direction. The robot 100 may obtain information about the viewing angle of the user 200 based on a user input.

According to an embodiment, the robot 100 may identify a first area in the line-of-sight range 710 of the user 200. The robot 100 may project the visual information 720 to the first area.

FIG. 7B is a diagram illustrating an example of an operation of the robot projecting visual information based on the line-of-sight range of the user according to an embodiment.

Referring to FIG. 7B, according to an embodiment, the robot 100 may identify a line-of-sight range 730 of the user 200. The robot 100 may identify an area (hereinafter, referred to as a “second area”) corresponding to the floor surface in the line-of-sight range 730 of the user 200. The robot 100 may project visual information 740 to a second area of the user 200.

In operation 530 of FIG. 5, according to an embodiment, the robot 100 may identify whether an event related to path guidance is detected through the sensor 130. The event, which is related to path guidance, may include detecting obstacles when the user is deviated from the path while moving.

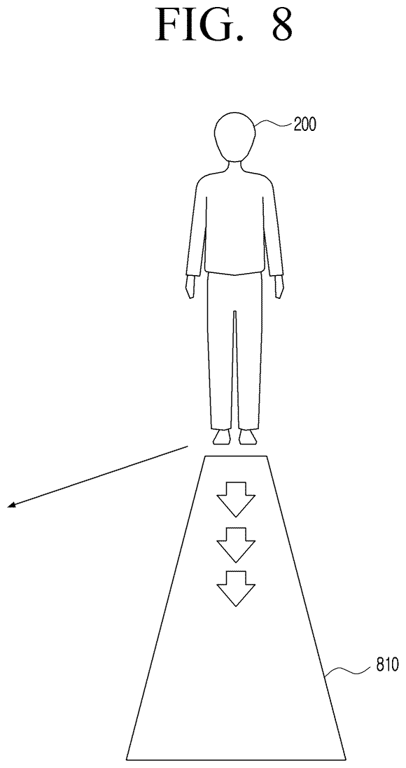

In operation 530-Y and operation 535 of FIG. 5, according to an embodiment, when an event related to path guidance is detected, the robot 100 may provide the user with the visual notification or the audible notification corresponding to the event. A method performed by the robot 100 for detecting an event and descriptions on the visual notification or the audible notification corresponding to the event will be described in detail below with reference to FIGS. 8, 9, and 10.

FIG. 8 is a diagram illustrating an example of an operation of a robot providing notification to a user when the user deviates from a path in a first mode according to an embodiment.

Referring to FIG. 8, according to an embodiment, the robot 100 may identify an area 810 corresponding to a path for the user 200 to move to a destination (hereinafter, referred to as a “first path”). For example, the robot 100 may identify an area corresponding to the moving direction from the position of the user 200 as the first path 810.

According to an embodiment, the robot 100 may identify, based on the user 200 being identified as moving to an area outside of the first path 810 through the sensor 130, the user 200 as being deviated from the path. For example, the robot 100 may identify, based on a position of the user 200 being identified as positioned in an area outside of the first path 810, the user 200 may be deviated from the path. In an example, the robot 100 may identify a position of the user 200 using the LiDAR sensor 132 or the camera 131. The robot 100 may identify, based on the position of the user 200 being identified as positioned in an area outside of the first path 810, the user 200 as having deviated from the path.

According to an embodiment, the robot 100 may identify, based on the user 200 being identified as moving to a direction different from the moving direction through the sensor 130, the user 200 as having deviated from the path. The direction different from the moving direction may include a direction with a difference greater than or equal to a preset angle (e.g., 20 degrees) with the moving direction.

According to an embodiment, when the user 200 is identified as having deviated from the path, the robot 100 may provide the user 200 with an audible notification to notify a state of the user 200 having deviated from the moving path. For example, the robot 100 may output an audible notification (e.g., “You are deviated from the path. Please move to the right.”) through the speaker 172.

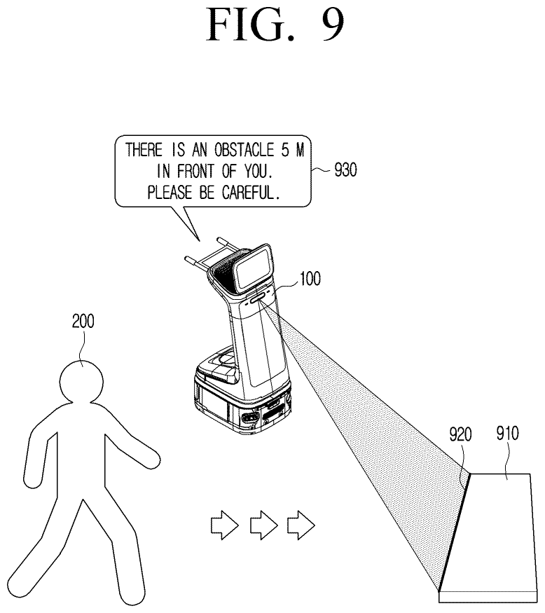

FIG. 9 is a diagram illustrating an example of an operation of a robot providing a notification to a user when an obstacle is detected in a first mode according to an embodiment.

Referring to FIG. 9, according to an embodiment, the robot 100 may detect an obstacle 910 of a first type using the sensor 130. The obstacle 910 of the first type may include geometry that can affect the walk of the user 200 such as stairs or a slope. In FIG. 9, an example of an operation of the robot 100 providing, based on identifying the obstacle 910 of the first type, a notification to the user 200 is described.

According to an embodiment, the robot 100 may detect the obstacle 910 using the LiDAR sensor 132. For example, the robot 100 may output a light signal using the LiDAR sensor 132 and detect the light signal reflected from an external object. The robot 100 may obtain information about a space using the detected light signal. The robot 100 may detect the obstacle 910 based on the information about the space.

According to an embodiment, the robot 100 may detect the obstacle 910 using the camera 131. For example, the robot 100 may obtain an image using the camera. The robot 100 may obtain geometry information based on an image and information about an object positioned in the space. The robot 100 may identify the obstacle using the geometry information and the information about the object. However, the embodiment is not limited thereto, and the robot 100 may identify the obstacle 910 based on an ultrasonic sensor, a ToF sensor, or a collision sensor.

According to an embodiment, when the obstacle 910 is identified, the robot 100 may project visual information 920 to the obstacle 910 using the projection part 140. According to an embodiment, the robot 100 may project the visual information 920 (e.g., yellow light signal) to an edge of the obstacle 910. The robot 100 may project the visual information 920 to the edge of the obstacle 910 based on information about the space obtained using the sensor 130.

For example, the robot 100 may obtain information (e.g., point cloud) about a space using the LiDAR sensor 132. The robot 100 may obtain a position of an edge of an obstacle (e.g., coordinates of the edge) by analyzing the information about the space. The robot 100 may control the projection part 140 to project the visual information 920 to an area corresponding to the position of the edge.

For example, the robot 100 may obtain the information about the space (e.g., depth map) using the camera 131. The robot 100 may obtain the position of the edge of the obstacle (e.g., coordinates of the edge) by analyzing the information about the space. The robot 100 may control the projection part 140 to project the visual information 920 to an area corresponding to the position of the edge.

According to an embodiment, the robot 100 may determine an intensity and/or output period of the visual information 920 based on a degree of risk of the obstacle 910. The degree of risk of the obstacle 910 may include a measure of an extent the obstacle 910 affects the walking of the user 200. For example, the degree of risk may increase as the extent of the obstacle 910 affecting the walk of the user 200 increases.

According to an embodiment, the robot 100 may identify the degree of risk of the obstacle 910 based on a height or a slope of the obstacle 910. The robot 100 may identify the height or the slope of the obstacle 910 based on information about the space obtained using the sensor 130.

According to an embodiment, the robot 100 may set the degree of risk of the obstacle 910 to be high as the height of the obstacle 910 increases. In an example, the robot 100 may obtain a first degree of risk (e.g., low risk) when the height of the obstacle corresponds to a first range (e.g., less than 10 cm), obtain a second degree of risk (e.g., medium risk) when the height of the obstacle corresponds to a second range (e.g., greater than or equal to 10 cm and less than 20 cm), and obtain a third degree of risk (e.g., high risk) when the height of the obstacle corresponds to a third range (e.g., greater than or equal to 30 cm).

According to an embodiment, the robot 100 may set the degree of risk of the obstacle 910 higher as an angle of the slope of the obstacle increases. In an example, the robot 100 may obtain the first degree of risk (e.g., low risk) when the angle of the slope of the obstacle corresponds to the first range (e.g., less than 10 degrees), obtain the second degree of risk (e.g., medium risk) when the angle of the slope of the obstacle corresponds to the second range (e.g., greater than or equal to 10 degrees and less than 20 degrees), and obtain the third degree of risk (e.g., high risk) when the angle of the slope of the obstacle corresponds to the third range (e.g., greater than or equal to 20 degrees).

According to an embodiment, the robot 100 may project the visual information 920 corresponding to the degree of risk of the obstacle 910. For example, the robot 100 may irradiate a stronger light signal in response to the higher degree of risk. For example, the robot 100 may output a light signal based on a period that is shorter as the degree of risk is higher. In an example, a light signal may be output based on a first period (e.g., 1 second) when the degree of risk of the robot 100 is the first degree of risk (e.g., low risk), a light signal may be output based on a second period (e.g., 0.5 seconds) when the degree of risk is the second degree of risk (e.g., medium risk), and a light signal may be output based on a third period (e.g., 0.1 seconds) when the degree of risk is the third degree of risk (e.g., high risk).

According to an embodiment, when the obstacle is identified or detected, the robot 100 may provide audible information 930 to the user 200 using the speaker 172. For example, the robot 100 may output a voice signal including information about a direction and distance of an obstacle (e.g., “There is an obstacle 5 m in front of you.”) through the speaker 172.

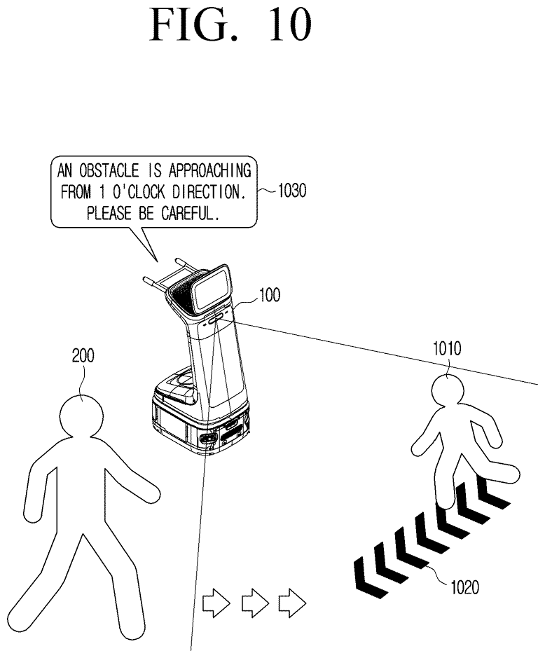

FIG. 10 is a diagram illustrating an example of an operation of a robot providing a notification to a user when an obstacle is detected in a first mode according to an embodiment.

Referring to FIG. 10, according to an embodiment, the robot 100 may detect an obstacle 1010 of a second type using the sensor 130. The obstacle 1010 of the second type may include a moving object such as a person, a pet, and the like. In FIG. 10, an example of an operation of the robot 100 providing, based on identifying the obstacle 1010 of the second type, a notification to the user will be described.

According to an embodiment, the robot 100 may detect the obstacle 1010 using the LiDAR sensor 132. The robot 100 may obtain information about a space at a plurality of time points (e.g., point cloud) using a light signal detected by the LiDAR sensor 132. The robot 100 may detect a moving obstacle 1010 by comparing a point cloud obtained from a first time point from among a plurality of time points with a point cloud obtained from a second time point from among the plurality of time points. When the robot 100 obtains an image based on a preset period, the second time point may mean a time point after a period is passed after the first time point.

The robot 100 may identify points that are different in position from points that form the point cloud obtained from the first time point from among the points that form the point cloud obtained from the second time point. The robot 100 may identify the moving obstacle 1010 by grouping the points that are different in position. The robot 100 may obtain a moving direction and a moving speed of the points that are grouped based on the point cloud obtained from the plurality of time points.

According to an embodiment, the robot 100 may detect the obstacle 1010 using the camera 131. For example, the robot 100 may obtain images at a plurality of time points using the camera 131. The robot 100 may detect the moving obstacle 1010 by comparing a first image obtained from the first time point from among the plurality of time points with a second image obtained from the second time point from among the plurality of time points. When the robot 100 obtains an image based on a preset interval, the second time point may mean a time point after a period is passed after the first time point. The robot 100 may obtain an area in which the obstacle 1010 is included by comparing pixel values of the second image with pixel values of the first image. The robot 100 may obtain the moving direction and the moving speed of the obstacle 1010 based on the images obtained from the plurality of time points.

According to an embodiment, the robot 100 may compare the moving direction and the moving speed of the obstacle 1010 with the moving direction and the moving speed of the user 200, and provide a notification to the user 200 when a moving path of the obstacle 1010 and the user 200 overlap.

According to an embodiment, the robot 100 may project visual information 1020 to the obstacle using the projection part 140.

According to an embodiment, the robot 100 may project the visual information 1020 to an area corresponding to the moving direction of the obstacle 1010. The visual information 1020 may include information about the moving direction of the obstacle 1010. The robot 100 may provide the user 200 with the moving direction of the obstacle 1010 in arrow form.

According to an embodiment, the robot 100 may determine an intensity and/or output period of the visual information 1020 based on a degree of risk of the obstacle 1010. According to an embodiment, the robot 100 may identify the degree of risk of the obstacle 1010 based on the speed of the obstacle 1010. The robot 100 may identify the speed of the obstacle 1010 based on the obstacle 1010 obtained by the sensor 130.

According to an embodiment, the robot 100 may set the degree of risk of the obstacle 1010 higher as the speed of the obstacle 1010 increases. In an example, the robot 100 may obtain the first degree of risk (e.g., low risk) when the speed of the obstacle corresponds to the first range (e.g., less than 4 km/h), obtain the second degree of risk (e.g., medium risk) when the speed of the obstacle corresponds to the second range (e.g., greater than or equal to 4 km/h and less than 8 km/h), and obtain the third degree of risk (e.g., high risk) when the speed of the obstacle corresponds to the third range (e.g., greater than or equal to 8 km/h)

According to an embodiment, the robot 100 may project the visual information 1020 corresponding to the degree of risk of the obstacle 1010. For example, the robot 100 may irradiate a stronger light signal when the degree of risk is higher. For example, the robot 100 may output the light signal based on a period that is shorter as the degree of risk is higher.

According to an embodiment, the robot 100 may provide audible information 1030 to the user 200 using the speaker 172. For example, the robot 100 may output a voice signal including information indicating a direction of an obstacle (e.g., “An obstacle is approaching from the 1 o'clock direction. Please be careful.”) through the speaker 172.

In operation 540 of FIG. 5, according to an embodiment, the robot 100 may identify whether the guide mode is the second mode. In operation 540-Y and operation 545, according to an embodiment, when the guide mode is identified as the second mode, the robot 100 may move to a destination to guide the user 200 to the destination. Because the operation for moving to a destination to guide the user 200 to the destination is described above in operation 520, redundant descriptions thereof will be omitted.

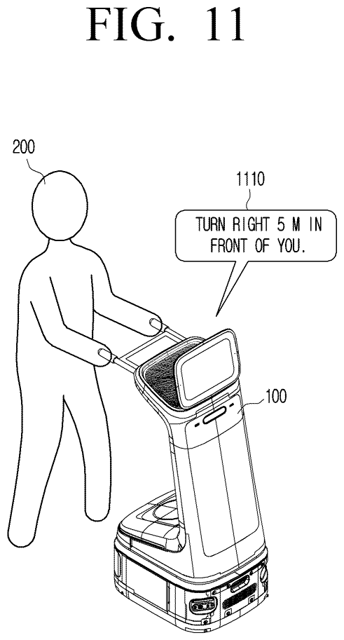

In operation 550 of FIG. 5, according to an embodiment, the robot 100 may provide the user 200 with an audible notification or a tactile notification to guide along a path while moving to the destination. Descriptions on an operation of the robot 100 providing the user 200 with an audible notification or a tactile notification to guide along a path in the second mode will be described in detail with reference to FIG. 11.

FIG. 11 is a diagram illustrating an example of an operation of a robot providing an audible notification or a tactile notification to guide a path to a user in a second mode according to an embodiment.

According to an embodiment, the robot 100 may provide the user 200 with audible information 1110 to guide along a path to a destination through the speaker 172. For example, the robot 100 may provide the user 200 with information about a moving direction (e.g., right turn, left turn, straight forward) and a moving distance (e.g., 5 m) by voice through the speaker 172. In an example, the robot 100 may provide the user 200 with a voice that includes audible information 1110 (e.g., “Turn right 5 m in front of you.”) based on the moving path.

According to an embodiment, the robot 100 may provide the user 200 with tactile information to guide along a path to a destination. For example, the robot 100 may display tactile information to guide along a path (e.g., “Turn right 5 m in front of you.”) in a braille display device (e.g., the braille display device 220 of FIG. 2). The tactile information may include information about the moving direction and the moving distance.

According to an embodiment, the robot 100 may provide the user 200 with tactile information by generating a vibration at the handles (e.g., the handle 210 of FIG. 2). For example, the robot 100 may provide tactile information to the user 200 based on a vibration position and/or number of vibrations. In an example, the robot 100 may generate vibration at a right handle when it is a right turn, and generate vibration at a left handle when it is a left turn. In an example, the robot 100 may control the number of vibrations proportional to the moving distance such as generating vibration once when the moving distance is 1 m, and generating vibration twice when the moving distance is 2 m.

In operation 555 of FIG. 5, according to an embodiment, the robot 100 may identify whether an event related to path guidance is detected through the sensor 130. The event related to path guidance may include detecting an obstacle when the user 200 is deviated from the path while moving.

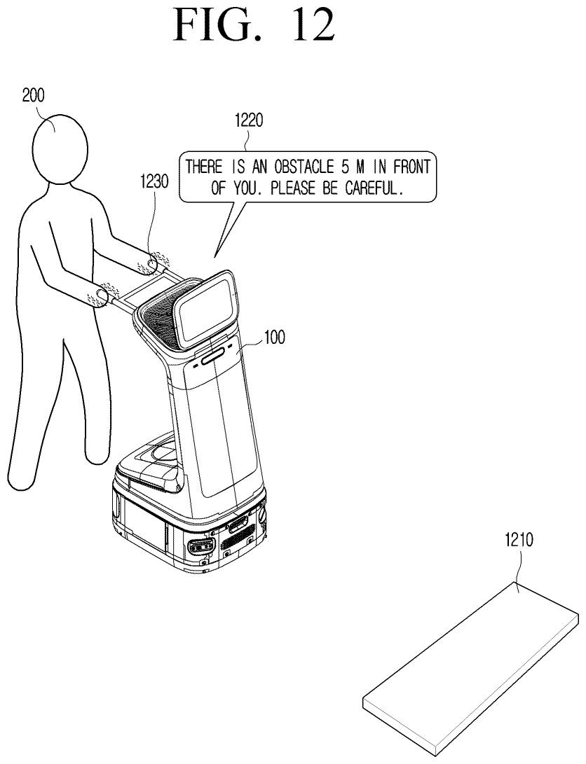

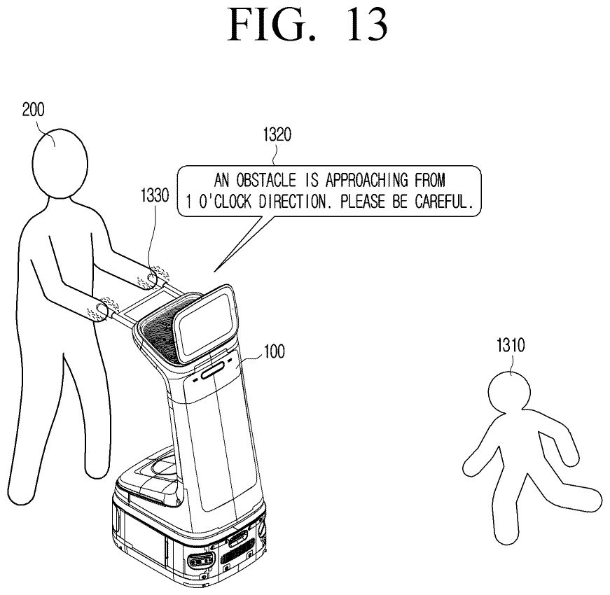

In operation 555-Y and operation 560 of FIG. 5, according to an embodiment, the robot 100 may provide the user 200 with the tactile notification or the audible notification corresponding to the event when the event related to path guidance is detected. A method performed by the robot 100 for detecting the event and descriptions on an operation for providing the user 200 with the tactile notification or the audible notification corresponding to the event will be described in detail below with reference to FIG. 12 and FIG. 13.

FIG. 12 is a diagram illustrating an example of an operation of a robot providing a notification to a user when an obstacle is detected in a second mode according to an embodiment.

Referring to FIG. 12, according to an embodiment, the robot 100 may detect an obstacle 1210 of the first type using the sensor 130. The obstacle 1210 of the first type may include geometry which is capable of affecting the walking of the user 200 such as stairs or a slope. Because the operation for detecting the obstacle 1210 of the first type is described above with reference to FIG. 9, redundant descriptions thereof will be omitted. In FIG. 12, an example of an operation of the robot 100 providing, based on identifying the obstacle 1210 of the first type, a notification to the user 200 will be described.

According to an embodiment, when the obstacle 1210 is identified or detected, the robot 100 may provide audible information 1220 to the user 200 using the speaker 172. For example, the robot 100 may output a voice signal including information about a direction and distance of an obstacle (e.g., “There is an obstacle 5 m in front of you.”) through the speaker 172.

According to an embodiment, when the obstacle 1210 is identified or detected, the robot 100 may provide the user 200 with tactile information. The tactile information may include information about the position of the obstacle. According to an embodiment, the robot 100 may display the tactile information indicating the position of the obstacle 1210 (e.g., “There is an obstacle 5 m in front of you. Please be careful.”) in the braille display device (e.g., the braille display device 220 of FIG. 2).

According to an embodiment, the robot 100 may provide the user 200 with tactile information by generating vibration at the handles (e.g., the handle 210 of FIG. 2). For example, the robot 100 may provide tactile information to the user 200 based on a vibration intensity and/or number of vibrations. In an example, the robot 100 may strongly output the vibration intensity when the obstacle 1210 is positioned at a first distance (e.g., less than 3 m), and weakly output the vibration intensity when positioned at a second distance (e.g., greater than or equal to 3 m). In an example, the robot 100 may output vibration based on different number of vibrations according to a type of the obstacle 1210. The robot 100 may output vibration a first time of vibrations (e.g., one vibration) when the obstacle 1210 is the stairs, and output a second time of vibrations (e.g., two vibrations) when the obstacle 1210 is the slope.

FIG. 13 is a diagram illustrating an example of an operation of a robot providing a notification to a user when an obstacle is detected in a second mode according to an embodiment.

Referring to FIG. 13, according to an embodiment, the robot 100 may detect an obstacle 1310 of the second type using the sensor 130. The obstacle 1310 of the second type may include a moving object such as a person or a pet. In FIG. 13, an example of an operation of the robot 100 providing, based on identifying the obstacle 1310 of the second type, a notification to the user 200 will be described. Because the direction for detecting the obstacle 1310 of the second type and the method for obtaining the moving direction and the moving speed of the obstacle 1310 of the second type is described above, redundant descriptions thereof will be omitted.

According to an embodiment, when the obstacle 1310 is detected, the robot 100 may provide the tactile information to the user 200. For example, the robot 100 may display audible information including information about a direction of the obstacle (e.g., “An obstacle is approaching from the 1 o'clock direction. Please be careful.”) through the braille display device (e.g., 220 in FIG. 2).

For example, the robot 100 may generate vibration at the handles 1330. For example, the robot 100 may provide tactile information to the user 200 based on the vibration intensity and/or the number of vibrations. In an example, the robot 100 may increase the vibration intensity or increase the number of vibrations as the speed of the obstacle 1310 increases.

According to an embodiment, when the obstacle 1310 is detected, the robot 100 may provide audible information 1320 to the user 200 using the speaker 172. For example, the robot 100 may output a voice signal including information about a direction of an obstacle (e.g., “An obstacle is approaching from the 1 o'clock direction. Please be careful.”) through the speaker 172.

In operation 565 of FIG. 5, according to an embodiment, the robot 100 may identify whether the guide mode is the third mode. In operation 565-Y and operation 570, according to an embodiment, when the guide mode is identified as the third mode, the robot 100 may move to a destination to guide the user 200 to the destination. Because the operation for moving to a destination to guide the user 200 to the destination is described in operation 520 and operation 545, redundant descriptions thereof will be omitted.

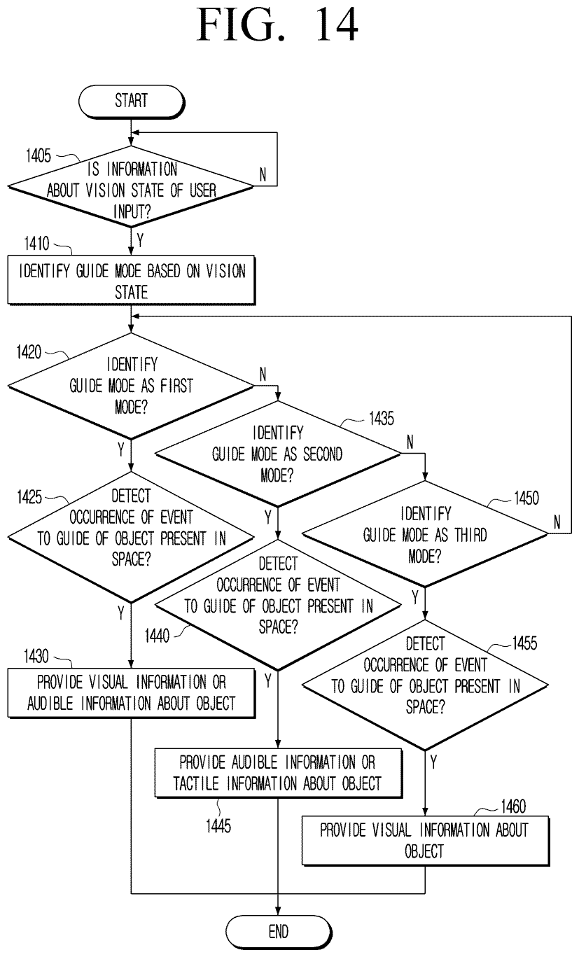

FIG. 14 is a flowchart illustrating an example of an operation of a robot providing a notification to a user according to an embodiment.

The processor 110 of the robot 100 may perform at least one operation from the operations of FIG. 14. Instructions stored in the memory 120 of the robot 100, which are executed by the processor 110 of the robot 100, may cause the robot 100 to perform the operations of FIG. 14.

In operation 1405 of FIG. 14, according to an embodiment, the robot 100 may identify whether the information about the vision state of the user 200 is input. Because descriptions on the operation for identifying whether the information about the vision state of the user 200 is input, are described above in operation 505 of FIG. 5, redundant descriptions thereof will be omitted.

In operation 1410 of FIG. 14, according to an embodiment, the robot 100 may identify the guide mode based on the vision state. Because the operation for identifying the guide mode based on the vision state is described above in operation 510 of FIG. 5, redundant descriptions thereof will be omitted.

In operation 1420 of FIG. 14, according to an embodiment, the robot 100 may identify whether the guide mode is the first mode. In operations 1420-Y and 1425 of FIG. 14, according to an embodiment, the robot 100 may identify, based on the guide mode being identified as the first mode, whether an occurrence of an event related to path guidance to an object that is present in a space is detected.

According to an embodiment, the robot 100 may identify, based on the object being identified as positioned nearby, an occurrence of an event related to path guidance to the detected object. The robot 100 may store information about a map corresponding to a space and a position information about an object in the memory 120. The space may mean an area traveled by the robot 100.

According to an embodiment, information about objects, positions of the objects, and notifications about the objects may be updated at initial manufacturing of the robot 100 or periodically updated based on the user input and stored in the memory 120. For example, it may be assumed that the space traveled by the robot 100 is an art gallery. For example, the objects may include works of art, guide signage, bathrooms, and the like.

According to an embodiment, the robot 100 may identify objects that require guidance by comparing the moving path with the positions of the objects. For example, the robot 100 may identify objects that are present on the moving path. In an example, when a first work of art, a second work of art, and a bathroom are positioned on the moving path, the robot 100 may identify the objects, for which guidance is to be provided to the user 200, as the first work of art, the second work of art, and the bathroom.

According to an embodiment, notification information about objects may include at least one from among the visual notification, the audible notification, or the tactile notification. The robot 100 may provide the user 200 with a notification corresponding to the event based on the guide mode based on an occurrence of an event related to path guidance to an object being detected.

According to an embodiment, the robot 100 may obtain the position information about the robot 100 using the sensor 130. The robot 100 may identify, based on a distance between the robot 100 and an object being identified as less than or equal to a preset distance (e.g., 3 m), an occurrence of an event related to path guidance to the detected object.

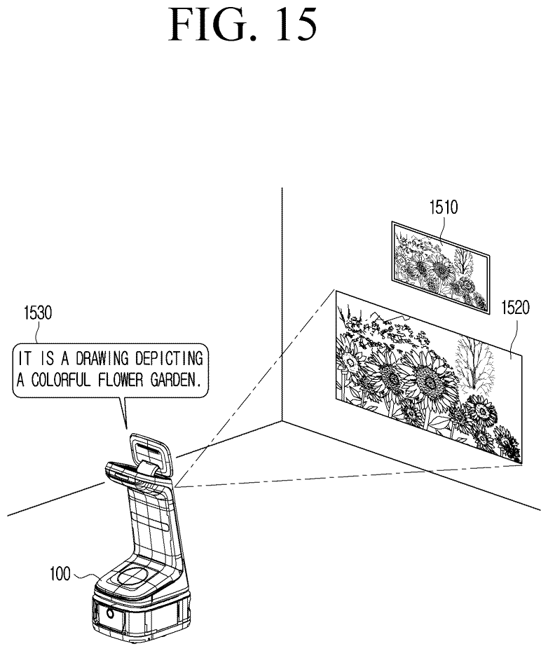

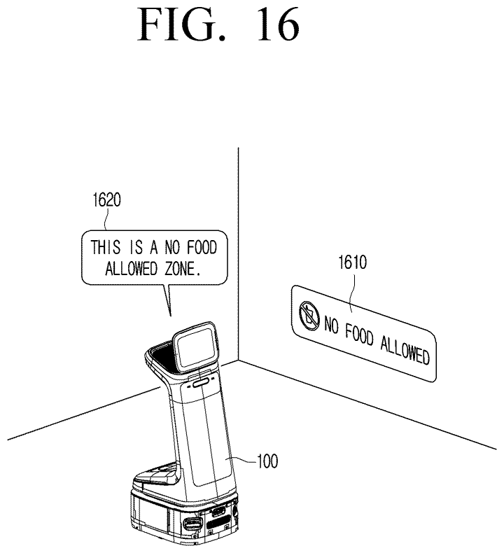

In operations 1425-Y and 1430 of FIG. 14, according to an embodiment, based on an occurrence of an event related to path guidance to an object present in a space having been detected, the robot 100 may provide a visual information or an audible information about the object. Descriptions on an operation of the robot 100 providing a visual information or an audible information about an object will be described in detail with reference to FIG. 15 and FIG. 16.

FIG. 15 is a diagram illustrating an example of an operation of a robot providing a notification to a user when an event related to path guidance to an object in a space is occurred in a first mode according to an embodiment.

According to an embodiment, the robot 100 may provide, based on a distance from an object 1510 (e.g., first work of art) being identified as less than or equal to a preset distance (e.g. 3 m), the visual information or the audible information about the object.

According to an embodiment, the robot 100 may project an image 1520 corresponding to the object 1510 near the object through the projection part 140. According to an embodiment, the robot 100 may display the image 1520 corresponding to the object 1510 on the display 171. The image 1520 corresponding to the object 1510 may include an image of a greater size than the actual size of the object 1510. For example, when the object 1510 is a drawing 1510, the robot 100 may project the image 1520 which is an enlargement of the size of the drawing 1510 near the drawing 1510. Although FIG. 15 shows the object being a drawing as an example, the embodiment is not limited thereto. For example, the object may include an object that requires guidance to the user 200, such as a work of art (e.g., ceramics, a sculpture, etc.), a book, signage, and the like. However, embodiments are not limited thereto.

According to an embodiment, the robot 100 may output a voice signal 1530 for describing the object 1510 (e.g., “It is a drawing depicting a colorful flower garden.”) through the speaker 172. For example, the voice signal 1530 for describing the image 1520 corresponding to the object 1510 and the object 1510 may be generated based on a user input and stored in the memory 120.

FIG. 16 is a diagram illustrating an example of an operation of a robot providing a notification to a user when an event related to path guidance to an object in a space is occurred in a first mode according to an embodiment.

According to an embodiment, the robot 100 may output, based on a text being identified on an object 1610, a voice signal about the text through the speaker 172. The robot 100 may obtain an image of the object 1610 using the camera 131. The robot 100 may identify the text included in the object 1610 (e.g., “This is a no food allowed zone.”) by inputting the image about the object 1610 in the artificial intelligence model. The robot 100 may output the identified text through the speaker 172.

In operation 1435 of FIG. 14, according to an embodiment, the robot 100 may identify whether the guide mode is the second mode. In operations 1435-Y and 1440 of FIG. 14, according to an embodiment, the robot 100 may identify, based on the guide mode being identified as the second mode, whether an occurrence of an event related to path guidance to an object in a space is detected. Because the operation for detecting an event related to path guidance to the object in the space is described above in operation 1425 of FIG. 14, redundant descriptions thereof will be omitted.

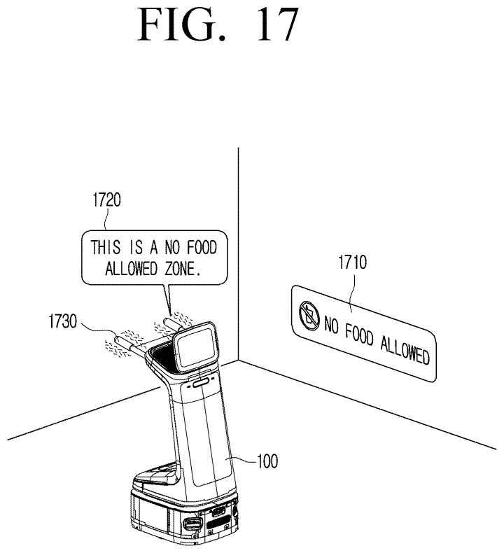

In operations 1440-Y and 1445 of FIG. 14, according to an embodiment, the robot 100 may provide an audible information or a tactile information about the object when the occurrence of the event related to path guidance to the object in the space is detected. Descriptions on an operation of the robot 100 providing an audible information or a tactile information about an object will be described in detail with reference to FIG. 17.

FIG. 17 is a diagram illustrating an example of an operation of a robot providing a notification to a user when an event related to path guidance to an object in a space is occurred in a second mode according to an embodiment.

According to an embodiment, the robot 100 may provide, based on a distance from an object 1710 being identified as less than or equal to a preset distance (e.g., 3 m), audible information or tactile information about the object.

According to an embodiment, the robot 100 may output text information included in the object 1710 (e.g., “This is a no food allowed zone.”) through the speaker 172. Because the operation for obtaining the text information included in the object 1710 is described above with reference to FIG. 16, redundant descriptions thereof will be omitted. According to an embodiment, the robot 100 may display the text information included in the object 1710 on a braille display device 1730.

In operation 1450 of FIG. 14, according to an embodiment, the robot 100 may identify whether the guide mode is the third mode. In operations 1450-Y and 1455 of FIG. 14, according to an embodiment, the robot 100 may identify, based on the guide mode being identified as the third mode, whether an occurrence of an event related to path guidance to an object in a space is detected. Because the operation for detecting the event related to path guidance to the object in the space is described above in operation 1425 and operation 1440 of FIG. 14, redundant descriptions thereof will be omitted.

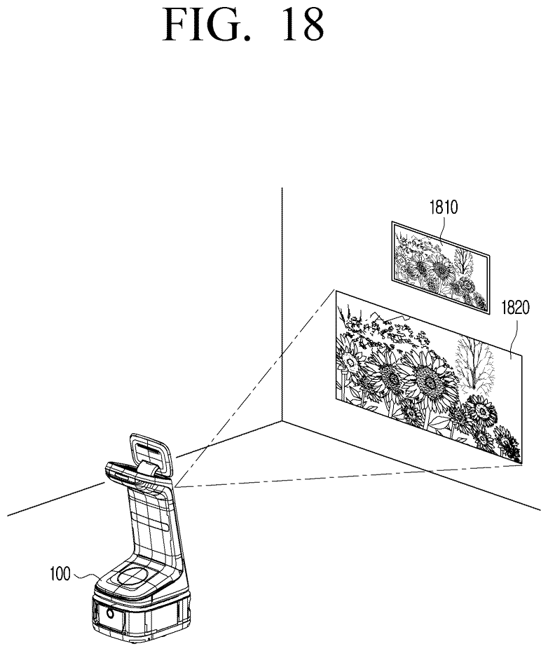

In operations 1455-Y and 1460 of FIG. 14, according to an embodiment, the robot 100 may provide a visual information or an audible information about the object when the occurrence of the event related to path guidance to the object in the space is detected. Descriptions on an operation of the robot 100 providing visual information or audible information about an object will be described in detail with reference to FIG. 18.

FIG. 18 is a diagram illustrating an example of an operation of a robot providing a notification to a user when an event related to path guidance to an object in a space is occurred in a third mode according to an embodiment.

According to an embodiment, the robot 100 may provide, based on a distance from an object 1810 (e.g., first work of art) being identified as less than or equal to a preset distance (e.g., 3 m), visual information or audible information about the object.

According to an embodiment, the robot 100 may project an image 1820 corresponding to the object 1810 near the object through the projection part 140. According to an embodiment, the robot 100 may display the image 1820 corresponding to the object 1810 on the display 171. The image 1820 corresponding to the object 1810 may include the image 1820 with increased color contrast of the object 1810. For example, when the object is a drawing 1810, the robot 100 may project the image 1820 which is an enlargement of the size of the drawing 1810 near the drawing 1810. Although FIG. 18 shows the object being a drawing as an example, the embodiment is not limited thereto. For example, the object may include objects that require guidance to the user 200, such as works of art (e.g., ceramics, sculptures, etc.), signage, and the like. However, embodiments are not limited thereto. For example, the robot 100 may provide the user 200 with a visual notification with increased color contrast of the object through the projection part 140 or the display 171.

According to an embodiment, the robot 100 may output a voice signal for describing the object 1810 (e.g., “It is a drawing depicting a colorful flower garden.”) through the speaker 172. For example, the voice signal for describing the image 1820 corresponding to the object 1810 and the object 1810 may be generated based on a user input and stored in the memory 120.

The technical problem(s) to be addressed by embodiments of the disclosure is not limited to the technical problem(s) described above, and other technical problems that may be addressed will be clearly understood by those of ordinary skill in the art.

In the above, each of the various embodiments is described, but each of the embodiments is not necessarily implemented individually, and may be combined as a whole or partially with at least one of the other embodiments and implemented together in one product.

For example, the embodiments of the disclosure may also be implemented in a form of a recording medium that includes computer executable instructions such as a program module which is executed by a computer. A computer-readable medium may be a random accessible medium accessible by the computer, and may include both volatile and non-volatile media, and removable and non-removable media. For example, the computer-readable medium may include a computer storage medium and a communication medium. The computer storage medium may include both the volatile and non-volatile media, and the removable and non-removable media which are implemented with a random method or technology to store information such as computer readable instructions, data structures, program modules or other data. The communication medium may include other data of a modulated data signal such as typical computer readable instructions, data structures, or program modules.

For example, the storage medium readable by the computer may be provided in a form of a non-transitory storage medium. Herein, the term “non-transitory storage medium” may be a device that is tangible, and merely means that it does not include a signal (e.g., electromagnetic waves), and the term does not differentiate data being semi-permanently stored or being temporarily stored in the storage medium. In an example, the term “non-transitory storage medium” may include a buffer in which data is temporarily stored.

According to an embodiment, a method according to the various embodiments described herein may be provided included in a computer program product. The computer program product may be exchanged between a seller and a purchaser as a commodity. The computer program product may be distributed in the form of a machine-readable storage medium (e.g., a compact disc read only memory (CD-ROM)), or distributed online (e.g., downloaded or uploaded) through an application store or directly between two user devices (e.g., smartphones). In the case of online distribution, at least a portion of the computer program product (e.g., downloadable app) may be stored at least temporarily in the machine-readable storage medium such as a server of a manufacturer, a server of an application store, or a memory of a relay server, or temporarily generated.

Descriptions of the disclosure described above are provided as examples, and it may be understood by those of ordinary skill in the art that the embodiments are easily modifiable to other detailed forms without changing the technical spirit or essential features of the disclosure. Accordingly, the embodiments described in the above are to be understood as examples from all aspects and not limiting. For example, each element described as a singular type may be distributed and implemented, and likewise, elements described as distributed may be implemented in a combined form.

The scope of the disclosure is represented by the claims described below rather than the detailed description above, and it is to be construed that all changes or modified forms derived from the meaning and scope of the claims and their equivalent concept are included in the scope of the disclosure.

What is claimed is:

1. A robot comprising:
a sensor;
a driving assembly configured to move the robot;
an input interface;
memory storing instructions; and
at least one processor comprising processing circuitry,
wherein the instructions, when executed by the at least one processor individually or collectively, cause the robot to:
identify a guide mode based on information about a vision state of a user received through the input interface,
based on identifying the guide mode being as a first mode, operate in the first mode, and based on an occurrence of an event related to path guidance being detected through the sensor during moving to a destination while operating in the first mode, provide a visual notification or an audible notification corresponding to the event, and
based on identifying the guide mode as a second mode, operate in the second mode, and based on the occurrence of the event related to the path guidance being detected by the sensor during moving to the destination while operating in the second mode, provide the audible notification or a tactile notification corresponding to the event.

2. The robot of claim 1, further comprising:
a projector comprising a light emitting device,
wherein the instructions, when executed by the at least one processor individually or collectively, cause the robot to, while operating in the first mode:
output light by the projector during moving to the destination, or
project visual information for the path guidance on a floor surface of a space by the projector.

3. The robot of claim 2, wherein the instructions, when executed by the at least one processor individually or collectively, cause the robot to:
identify a line-of-sight range of the user through the sensor, and
project, by the projector, the visual information on the floor surface in the line-of-sight range of the user.

4. The robot of claim 2, wherein the instructions, when executed by the at least one processor individually or collectively, cause the robot to:
based on an obstacle being detected through the sensor during moving to the destination while operating in the first mode, project, by the projector, visual information to the obstacle.

5. The robot of claim 4, wherein the instructions, when executed individually or collectively by the at least one processor, cause the robot to:
identify a moving direction of the user by the sensor, and
based on the obstacle being detected in the moving direction, project, by the projector, a light signal to an edge area of the obstacle.

6. The robot of claim 5, wherein the instructions, when executed by the at least one processor individually or collectively, cause the robot to:
identify a degree of risk of the obstacle based on at least one from among a height of the obstacle, a slope of the obstacle, or a speed of the obstacle, and
project the light signal based on a period corresponding to the degree of risk.

7. The robot of claim 1, further comprising:
a speaker,
wherein the instructions, when executed by the at least one processor individually or collectively, cause the robot to:
based on identifying through the sensor that the user has deviated from a path during moving to the destination, output, by the speaker, the audible notification indicating a state in which the user deviated from a moving path while operating in the first mode or the second mode.

8. The robot of claim 1, further comprising:
a speaker,
wherein the instructions, when executed by the at least one processor individually or collectively, cause the robot to:
output, by the speaker, the audible notification for the path guidance to the destination or output, based on an obstacle being detected by the sensor during the moving to the destination, the audible notification indicating detection of the obstacle by the speaker while operating in the second mode.

9. The robot of claim 1, wherein the instructions, when executed by the at least one processor individually or collectively, cause the robot to:
provide a vibration notification for indicating a change in a moving direction of the robot or detection of an obstacle while operating in the second mode.

10. The robot of claim 1, wherein the instructions, when executed by the at least one processor individually or collectively, cause the robot to:
based on identifying the guide mode as a third mode, operate in the third mode, and move the robot to the destination to guide the user to the destination.

11. The robot of claim 10, wherein the instructions, when executed by the at least one processor individually or collectively, cause the robot to:
based on an occurrence of an event related to path guidance to an object present in a space being detected through the sensor during moving to the destination while operating in the first mode, provide the visual notification or the audible notification about the object,
based on the occurrence of the event related to the path guidance to the object present in the space being detected through the sensor during moving to the destination while operating in the second mode, provide the audible notification or the tactile notification about the object, and
based on the occurrence of the event related to the path guidance to the object present in the space being detected through the sensor during moving to the destination while operating in the third mode, provide the visual notification about the object.

12. The robot of claim 11, further comprising:
a projector; and
a speaker,
wherein the instructions, when executed by the at least one processor individually or collectively, cause the robot to, while operating in the first mode:
project an image corresponding to the object near the object in a size greater than a size of the object by the projector, or
output a voice signal describing the object or a voice signal for a text recognized in the object by the speaker.

13. The robot of claim 11, further comprising:
a speaker,
wherein the instructions, when executed by the at least one processor individually or collectively, cause the robot to, while operating in the second mode:
output a voice signal describing the object or a voice signal for a text recognized in the object by the speaker, or
provide a text describing the object or a text recognized in the object by a braille display device.

14. The robot of claim 11, further comprising:
a projector,
wherein the instructions, when executed by the at least one processor individually or collectively, cause the robot to:
project, by the projector, near the object by increasing color contrast of an image corresponding to the object while operating in the third mode.

15. A method of controlling a robot, the method comprising:
identifying a guide mode based on information about a vision state of a user;
based on identifying the guide mode as a first mode, operating in the first mode, based on an occurrence of an event related to path guidance being detected during moving to a destination while operating in the first mode, providing a visual notification or an audible notification corresponding to the event; and
based on identifying the guide mode as a second mode, operating in the second mode, and based on the occurrence of the event related to the path guidance being detected during moving to the destination while operating in the second mode, the audible notification or a tactile notification corresponding to the event.

16. The method of claim 15, further comprising, while operating in the first mode:
outputting, by a projector of the robot, light during moving to the destination; or
projecting, by the projector, visual information for the path guidance on a floor surface of a space.

17. The method of claim 16, further comprising:
identifying a line-of-sight range of the user through a sensor of the robot, and
projecting, by the projector, the visual information on the floor surface in the line-of-sight range of the user.

18. The method of claim 16, further comprising, based on an obstacle being detected through a sensor of the robot during moving to the destination while operating in the first mode, projecting, by the projector, visual information to the obstacle.

19. The method of claim 18, further comprising:
identify a moving direction of the user by the sensor, and
based on the obstacle being detected in the moving direction, projecting, by the projector, a light signal to an edge area of the obstacle.

20. The method of claim 19, further comprising:
identifying a degree of risk of the obstacle based on at least one from among a height of the obstacle, a slope of the obstacle, or a speed of the obstacle, and
based on the obstacle being detected in the moving direction, projecting, by the projector, the light signal to an edge area of the obstacle.
